(19) United States
(12) Patent Application Publication
(10) Pub. No.: US 2016/0200087 A1
(43) Pub. Date: Jul. 14, 2016

(54) SUPPORT STRUCTURE FOR A MOTOR VEHICLE AND METHOD FOR PRODUCING A SUPPORT STRUCTURE FOR A MOTOR VEHICLE

(71) Applicant: BENTELER Automobiltechnik GmbH, Paderborn (DE)

(72) Inventors: Jochen DOERR, Bad Driburg (DE); Konstantin TATARINOV, Bielefeld (DE)

(73) Assignee: BENTELER Automobiltechnik GmbH, Paderborn (DE)

(21) Appl. No.: 14/992,212

(22) Filed: Jan. 11, 2016

(30) Foreign Application Priority Data
Jan. 9, 2015 (DE) 102015100261.2

(51) Int. Cl. B32B 37/12; B23K 31/02

(52) U.S. Cl. CPC B32B 37/12; B23K 31/02; B32B 2605/00

(57) ABSTRACT

The invention relates to a support structure (1) for a motor vehicle, said support structure comprising at least one first and one second hollow profile (2, 3), with both hollow profiles being arranged one inside the other in an overlapping region (4) and with both hollow profiles being arranged in the overlapping region (4) in such a way that they abut each other at least in certain regions, wherein the inner first hollow profile (2) has a plurality of beads (5, 11), which extend in the axial direction A and are arranged in the circumferential direction U, at least in the overlapping region (4).

Furthermore, the invention relates to a method for producing such a support structure (1) for a motor vehicle, wherein at least the first hollow profile (2) is deformed in such a way that the walls of the first hollow profile (2) are pulled inward in certain regions in an overlapping region (4) of the two hollow profiles (2, 3), so that beads (5, 11), which extend in the axial direction A and are arranged so as to be spaced apart in the circumferential direction U, are formed. The hollow profiles (2, 3) are arranged one inside the other in such a way that the outer surface of the inner first hollow profile (2) comes into contact with the inner surface of the outer second hollow profile (3) at least in certain regions in an overlapping region (4).

The invention relates to a support structure for a motor vehicle in accordance with the preamble of patent claim 1 as well as a method for producing a support structure for a motor vehicle in accordance with patent claim 14.

It is known from the prior art to produce a support structure for a motor vehicle from several individual elements. In this case hollow profiles are often used that are joined to each other in a variety of ways. The multi-part design of such a support structure offers many advantages in terms of assembly and also with respect to the use of materials. Then different materials can be combined in a support structure. This approach ensures that the support structure or other components of the vehicle can be produced in terms of their mechanical properties to the specifications of their application.

The U.S. Pat. No. 6,817,382 B2 describes a support structure for a motor vehicle, with the support structure comprising two tubular hollow profiles that are arranged partially one inside the other. The hollow profiles are pressed into each other and, as a result, are deformed, so that a press fit is formed.

The object of the present invention is to provide a multi-part support structure for a motor vehicle in such a way that its connection of the individual parts is improved over the prior art and is easy and simple to assemble. Furthermore, the invention proposes a method for producing such a support structure.

The objective part of the invention is achieved by means of a support structure exhibiting the features disclosed in patent claim 1. Particular embodiments of the support structure are the subject matter of the dependent claims 2 to 13. The procedural part of the engineering object is achieved by means of a method for producing a support structure exhibiting the features disclosed in patent claim 14. Particular embodiments of the method are the subject matter of the dependent claims 15 to 22.

The invention relates to a support structure for a motor vehicle, said support structure comprising at least one first and one second hollow profile, with both hollow profiles being arranged one inside the other in an overlapping region and with both hollow profiles being arranged in the overlapping region in such a way that they abut each other at least in certain regions, wherein the inner first hollow profile has a plurality of beads, which extend in the axial direction and are arranged so as to be spaced apart in the circumferential direction, at least in the overlapping region.

The term “axial direction” is defined herein as the direction of the substantially longitudinal extent of the respective hollow profile or also the support structure, hence, the direction, parallel to which the walls of the hollow profile more or less extend.

In this context the extent in the axial direction includes both the alignment of the beads parallel to the axial direction and the alignment of the beads at an angle, thus, transversely to the axial direction. Preferably the expansion of the beads in the axial direction is greater than perpendicular thereto. However, it is also conceivable for the beads to have about the same dimensions parallel and perpendicular to the axial direction; and it is possible to produce short, for example, square beads.

For the sake of simplicity mostly a support structure, which consists of two hollow profiles and has consequently only one overlapping region, is described below. However, according to the invention, this support structure may also consist of several hollow profiles. In that case then there would also be several overlapping regions.

This embodiment of a multi-part support structure offers several advantages. At least two hollow profiles are arranged one inside the other and are also inserted into one another, the effect of which is that an overlapping region of the two hollow profiles is produced. If two nondeformed profiles are arranged one inside the other and, thereafter, they are supposed to stay fixed, then the necessary press fit places a high demand on the geometric precision of the hollow profiles. Therefore, according to the invention, at least the inner first hollow profile is deformed in such a way that it has a plurality of beads that extend in the axial direction of the profile and that are arranged in the circumferential direction. In the region of the beads the deformation generates restoring forces, which act radially outwards, in the material of the hollow profile. These forces cause the inner first hollow profile to be pressed against the inner wall of the outer second hollow profile. The resulting press fit is stronger than the press fit of profiles that are not deformed at all, so that the strictly non-positive connection of the hollow profiles of the support structure is already optimized.

Particularly suitable in this case is the use of a lightweight metal material, such as, for example, aluminum, for an inner hollow profile, for instance, as a component in a support structure, which consists of a material mix and in which the other profile components or more specifically the outer hollow profile is/are made of a steel material. Lightweight metals, such as, for example, aluminum, have a higher restoring force than steel materials after a deformation, so that the corresponding profiles should be inserted in such a way that they lie inside. The outside steel profile can then he used as an abutment.

In this respect the resulting press fit does not have to be designed in such a way that it ensures a permanent connection between the profiles. If a material bonded joint, such as, for example, a glued joint, welded joint or soldered joint, is provided, then the press fit can also be used to fix the individual hollow profiles relative to each other, until the adhesive has cured or in order to prevent the components from distorting during the welding operation. This measure makes it particularly easy to assemble a support structure according to the invention. At the same time the load is removed from the material bonded joint.

Additional advantages are explained in accordance with the specific embodiment of the invention described below.

The number of beads depends on the actual boundary conditions, for example, the dimensions of the profiles, the application of the support structure and the forces of the joint to be generated. Even for the degree of deformation the person skilled in the art will be guided by the structural conditions. In this respect it is useful to deform the profile over its entire periphery. The profile may be deformed just as well only locally; and, thus, the individual beads may be arranged at a greater distance from each other. Then the outer circumference of the deformed region is identical to the original outer circumference of the profile. Even the depth of the beads, measured in the radial direction, may vary from bead to bead.

Optionally it is also practical to arrange several rows of beads, arranged in the circumferential direction, in the overlapping region, with the beads being spaced apart from each other in the axial direction. In this case the beads of one row are arranged so as to be offset from the beads of another row or may be aligned flush therewith.

Prior to the deformation the hollow profiles exhibit preferably a round or elliptical cross section at the sections that are arranged one inside the other. In principle, however, any arbitrary cross sectional shape may be selected, for example, in order to be able to meet the space specifications or the stiffness requirements.

In this ease there is a high degree of variability, because the wall thicknesses and the cross sections of the profiles may also vary locally over a wide range. The steel profiles can be manufactured from a sheet in a UO forming process, where said sheet can also be provided with different wail thickness in a preceding rolling process and can be cut to size according to the predetermined cross section of the profile.

One preferred embodiment of the support structure provides that the beads of the first hollow profile extend from its end, disposed in the second hollow profile, in the axial direction. In particular, in the case of a welded or soldered joint between the individual profiles this measure offers here the advantage that the beads allow the welding or soldering gases to escape.

Furthermore, it is preferably provided that the outer second hollow profile also has beads that engage at least partially with the beads of the inner first hollow profile. The effect in this case is also that this arrangement secures the individual profiles against rotation relative to each other; and, in addition, a positive connection is formed in the axial direction. This feature also improves the joint between the hollow profiles. In particular, the aspect of the improved press fit due to the restoring forces is reflected in this arrangement.

A skillful choice of materials will make it possible to utilize this effect in an especially easy way. Hence, one uses a material that has a greater restoring effect, such as, for example, a lightweight metal, like aluminum, for the inside component and a material having a smaller restoring effect, such as, for example, a steel, for the outside component, as already described above. Both profiles are deformed to the same high degree, if both profiles have beads that engage with each other, so that in this case the resulting different restoring forces are very effective.

In this case it is also possible for the inner hollow profile to have more beads than the outer hollow profile. As described further below, the beads of the inner hollow profile may also he used as reservoirs for the adhesive, the welding material or solder. However, this feature demands that the outer profile does not completely engage or does not engage at all with the beads under discussion. It also makes it clear that the two profiles do not necessarily have to rest with their entire surface against each other inside the beads.

An additional preferred embodiment of the invention provides that the beads extend beyond the overlapping region. Such a measure is used to reinforce or stiffen the hollow profile(s) away from the overlapping region. It is also possible to use such beads as the attachment points for add-ons.

Preferably the beads and/or indentations and/or recesses are also introduced into the hollow profile in such a way that they are spaced apart from the overlapping region. This aspect is also used to improve the stiffness of the support structure. However, at the same time or as an alternative, these embodiments can also be provided as attachment points for add-ons of the support structure; or these embodiments may be used to attach the support structure itself to other components.

Furthermore, it is considered to be advantageous for at least one of the hollow profiles to have a cross section that varies in the axial direction. As a result, the inventive support structure can be adapted to the expected loads and can be produced to the specifications of its mechanical properties. This aspect offers a wide range of design flexibility, in particular, away from the overlapping region. The support structure may have a large cross section, at the place where the highest loads can be expected, whereas the rest of the regions may be provided with a smaller cross section, thus, reducing the amount of space and material used. For example, a large diameter is necessary at the location, where the steering and heavy instruments are disposed in an instrument panel support structure.

It is particularly preferred that at least one of the two hollow profiles has a cross section that tapers in the direction of the overlapping region. In particular, the inner hollow profile has a cross section that tapers in the direction of the overlapping region. This arrangement offers the possibility of optimizing the behavior in the event of collisions, because, when a compressive load is applied in the axial direction of the support structure, the respective hollow profiles are supported on each other, so that the effect is a stiffer and more stable support structure.

It can also be provided that in the case of at least one of the two hollow profiles the end, which is located on or in the overlapping region, is widened. This is especially the case for the inner hollow profile. This feature also has a positive effect on the stability of the joint, with this being the case, in particular, for tensile loads. The term “widening” is construed to mean, for example, a flaring of the end, but also a forming operation to create a trumpet-shaped end of the profile. A firm-fitting connection can be produced by means of an expanded end of the inner hollow profile, especially if the outer hollow profile has a cross section that tapers off in the direction of the overlapping region.

Another particular embodiment provides that at least one of the hollow profiles has locally varying wall thicknesses. In this case the inventive support structure can be adapted to the expected loads and can be produced to the specifications of its mechanical properties. With respect to optimizing the amount of the materials used, both the production costs and the weight can be reduced.

One hollow profile is made preferably of a steel material; and one hollow profile is made preferably of a light metal material. It is particularly preferred that the first hollow profile be made of a light metal material, and that the second hollow profile be made of a steel material. The use of different materials represents another way of adapting the inventive support structure to the desired requirements and of tailoring said inventive support structure to the respective application and the expected load conditions. In particular, the use of light weight metals takes into consideration the idea of a weight saving construction, which is the predominant factor in the production of modern motor vehicles.

The advantageous use of steel materials for one of the hollow profiles has already been described above. In this respect the UO forming process offers particular advantages. The sheet, on which then the hollow profile is based, can already be provided with variations in the respective wall thickness and can be prepared by suitably trimming to the end geometry of the profile.

After forming the hollow profile, its edges, which are now ideally standing one on top of the other, are welded to each other at least in sections. Dispensing with a continuous weld makes it possible to cut down the production time and to reduce the weight of the profile. Both of these features also lead to financial advantages.

In principle, a high strength or ultra-high strength material with an Rm>800 MPa is used for cold-formed profiles, while for hotformed profiles materials with an Rm>1,500 MPa are used.

For light metal profiles preferably magnesium materials or aluminum materials are used; even more preferred are aluminum alloys of the 6000 series in compliance with EN537. The profiles are produced preferably in a pultrusion or extrusion process.

Another preferred embodiment of the invention provides that one of the hollow profiles has a coating, made of a metallic material, on at least its surface regions that come into contact with another hollow profile. This feature is especially relevant if both profiles are made of different materials, as described above. The coating, in particular, for the steel profile, may be, for example, a zinc coating, in order to ensure protection against corrosion. However, it may also be an aluminum coating, in order to help join the two hollow profiles by means of a welding or soldering process.

Furthermore, it is preferably provided that the two hollow profiles are joined to each other by material bonding at least in certain regions. This aspect of the connection between the two hollow profiles has already been discussed several times. In particular, the material bonded joint is carried out as a glued joint, a welded joint or a soldered joint. The material bonded joint can be carried out locally, but also over the entire area between the hollow profiles. Especially in the case of a glued joint the effect of said bonded joint is not only a particularly stable connection, but it also provides at the same time protection against corrosion due to the adhesive.

In a further development of the invention it is provided that the beads of the first hollow profile are filled with adhesive, welding material, or soldering material in the overlapping region. In order to he able to guarantee a stable material-bonded joint, it is necessary to dispose the adhesive, the solder or also the welding material at the designated locations. In addition to improving the press fit, the beads in the inner hollow profile also help to improve the assembly of the inventive support structure by completely or partially filling said beads with adhesive, welding material or soldering material in a solid form or also in as liquid form before the hollow profiles are arranged one inside the other. This approach allows the material to be introduced into the space between the two hollow profiles in an advantageous way. The press fit ensures that the two profiles are not displaced relative to each other while the adhesive is curing or while the welding or soldering material is cooling. Thereafter the adhesive, the welding material or the soldering material also completely or partially fills the beads of the inner profile.

It is particularly preferred that the inventive support structure be an instrument panel support structure.

In addition, the invention relates to a method for producing a support structure for a motor vehicle, said method comprising the following steps:
providing at least one first and one second hollow profile
deforming at least the first hollow profile in such a way that the walls of the first hollow profile are pulled inward in certain regions in an overlapping region of the two hollow profiles, so that beads, which extend in the axial direction and are arranged so as to be spaced apart in the circumferential direction, are formed
arranging the first and second hollow profile one inside the other in such a way that before or after deforming the first hollow profile, the outer surface of the inner first hollow profile comes into contact with the inner surface of the outer second hollow profile at least in certain regions in an overlapping region.

In this context the first hollow profile is deformed preferably only locally, so that the original geometry of the profile remains between the beads in the circumferential direction. However, the profile can also be completely deformed in the circumferential direction.

The integral forming of the beads into the inner hollow profile causes a restoring force to be generated in the deformed regions, so that the result is an improved press fit that connects the hollow profiles. The strength of the press fit can also be adjusted by the degree of deformation. With respect to other advantages and options reference is made to the statements above.

In a preferred embodiment a layer of adhesive or weld or soldered joint for forming a material bonded joint between the two hollow profiles is arranged at least in certain regions between the first and the second hollow profile. Depending on the strength of the press fit that is formed, on the one hand, this press fit can be supported and the connection of the hollow profiles can be strengthened; and, on the other hand, the material bonded joint can also dominate, and the press fit can be used to hold the profiles in such a way that they cannot shift relative to each other until the material bonded joint is produced.

The first hollow profile is deformed preferably before the hollow profiles are arranged one inside the other. Then when the first hollow profile is inserted into the second hollow profile, the outer surface of the inner first hollow profile comes into contact with the inner surface of the outer second hollow profile in certain regions. This arrangement offers the advantage that the effect of merely arranging the hollow profiles one inside the other is a stable connection between the two parts. The beads are produced preferably in a forming tool with a top and bottom tool. Then it is advantageous if an even number of beads are introduced symmetrically into the hollow profile by means of a stamping process. In this case preference is given, in particular, to stamping with six beads. However, defined very loosely, the number and size of the beads also depend on the dimensions of the hollow profile.

If the beads are introduced into the inner hollow profile before the hollow profiles are arranged one inside the other, then it is particularly preferred in another process step to fill the beads of the inner first hollow profile with an adhesive, a welding material or a soldering material before the hollow profiles are arranged one inside the other. The resulting advantages associated with such a feature have also been shown above, so that at this point reference is only made thereto.

In addition, prior to arranging one inside the other, the outer hollow profile is preferably heated at least in certain regions, in particular, on the end that subsequently forms the overlapping region. The temperature rise causes the hollow profile to expand and then shrink after joining together with the inner hollow profile on said outer hollow profile. The net result is a simplification of the assembly of the support structure according to the invention.

One preferred embodiment of the invention provides that the inner first hollow profile and the outer second hollow profile are deformed after arranging one inside the other. The result of such a deformation step is generally that both hollow profiles are deformed simultaneously, provided that the deformation takes place in the overlapping region. However, this does not rule out that the first inner hollow profile has not already been deformed before arranging one inside the other. In particular, a performing operation can take place; or at the same time the reservoirs for the adhesive, the welding material or the soldering material can be produced.

It is even more preferred that the first and the second hollow profiles be deformed together in such a way that in the overlapping region the walls of the hollow profiles are pulled inwards, so that beads are formed; and the beads of the outer second hollow profile engage with the beads of the inner first hollow profile.

In this process variant beads are introduced into both hollow profiles. Both hollow profiles are then arranged one inside the other. In this case a press fit, thus, both hollow profiles come into total contact, is useful, but not necessary. Instead, the hollow profiles can also be arranged at a defined distance from each other; and the inner or outer surfaces do not come into contact until during the deforming process. Then both hollow profiles are deformed. This procedure has the advantage that a form fit is produced at least in the circumferential direction; and this form fit makes the connection between the two hollow profiles especially secure against rotation. In particular, this feature makes it possible for the entire surface of both profiles to come into contact in the region of the beads.

Another variant of the invention provides that outward projecting attachment elements are formed in at least one of the two hollow profiles. These attachment elements project more or less radially outwards and can still be machined after the production of the hollow profile(s).

Preferably at least one of the two hollow profiles is mechanically processed before and/or after arranging one inside the other. The term “mechanically processed” may be construed to mean the introduction of beads, grooves or recesses or any other type of forming, trimming, stamping or bending process.

Preferably at least one of the two hollow profiles is produced by means of a UO forming process. In particular, a steel material, which is provided in the form of sheets or coils, is used for this purpose. With respect to the properties of such a steel material reference is made to the features described above. The material can be produced with varying wall thicknesses in a rolling process. The UO forming process also makes it possible to provide the corresponding hollow profiles with cross sections that vary over its length. For this purpose the material has to be suitably trimmed beforehand.

The UO forming process also makes it possible to produce the above described attachment elements during the forming process by executing, for example, flanges on the edges of the sheets or the strip material. After the hollow profile has been finished, these flanges may be trimmed.

Preferably at least one of the two hollow profiles is produced by an extrusion or pultrusion process. In particular, a light metal material, for example, aluminum or magnesium, or a corresponding alloy is used here. With respect to the properties of said light metal material, reference is made to the features described above.

The extrusion or pultrusion process makes it also possible to form the above described attachment elements during the process. After the hollow profile has been finished, these attachment elements can be trimmed, so that the results are, for example, holding flanges for other add-ons.

The invention is explained in greater detail below by means of exemplary embodiments with reference to the accompanying figures. In this case the same reference numerals and characters are used for identical or analogous components of the invention.

The drawings show in:

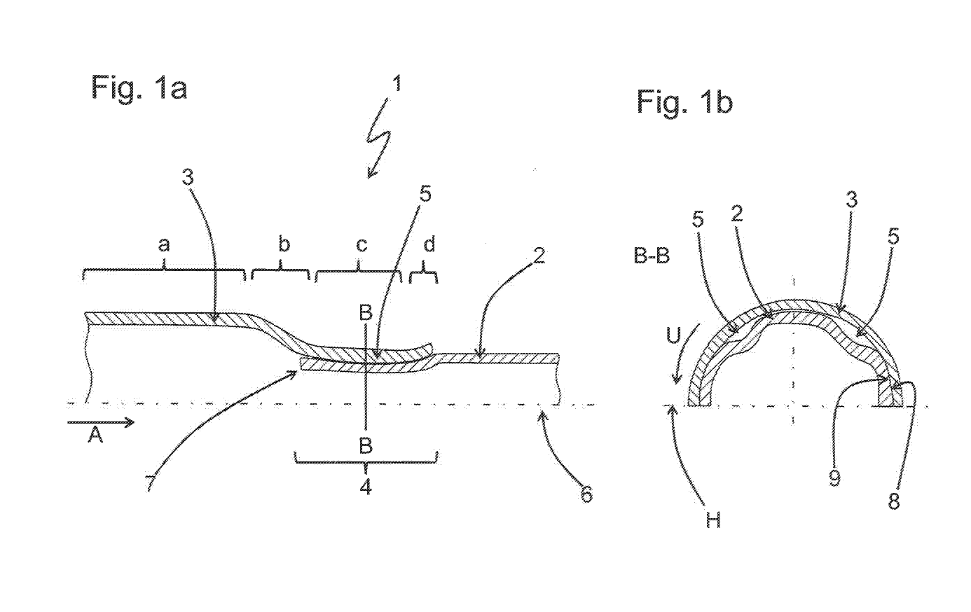

FIGS. 1a and 1b: a first embodiment of two hollow profiles that are connected to each other.

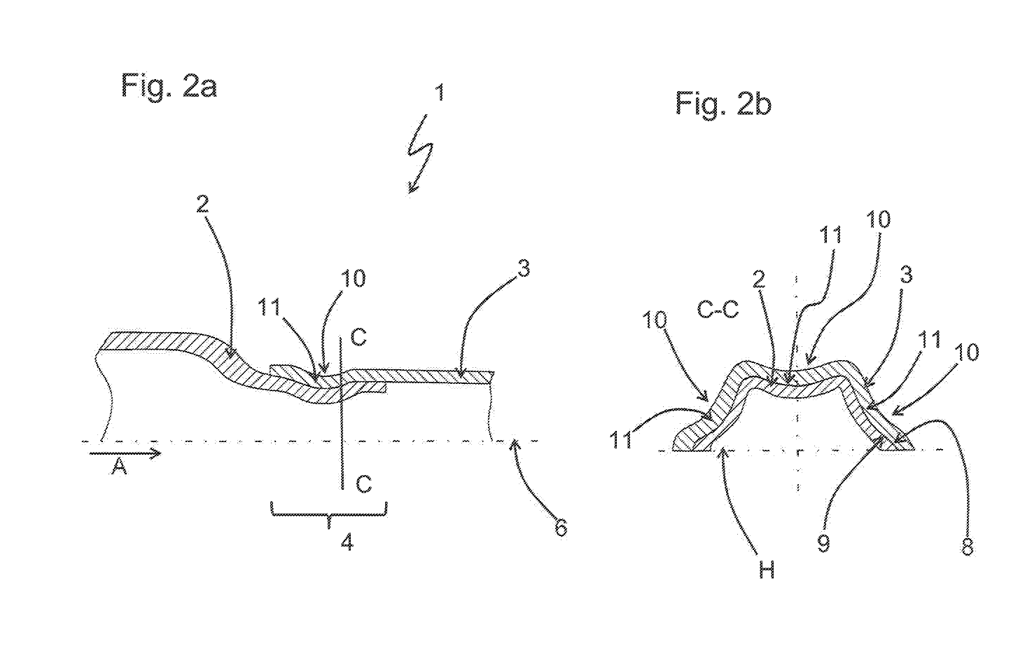

FIGS. 2a and 2b: a second embodiment of two hollow profiles that are connected to each other.

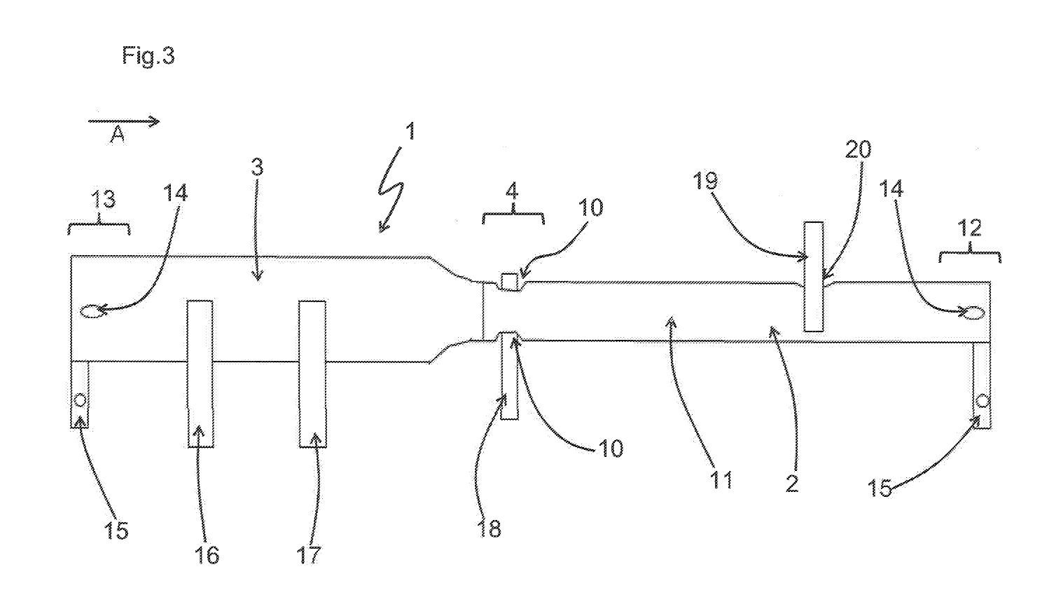

FIG. 3: an instrument panel support structure that is designed according to the invention.

According to the invention, a support structure 1 comprises at least one first hollow profile 2 and one second hollow profile 3. Both hollow profiles are arranged one inside the other in an overlapping region 4. Each of the FIGS. 1(a and b) and 2(a and b) shows this overlapping region 4 of the support structure 1, with the connection between the two hollow profiles 2, 3 being designed in a different way in each instance. The hollow profiles 2, 3 are basically tubular hollow profiles with a more or less round cross section with a longitudinal axis 6. The first hollow profile 2 is arranged in the second hollow profile 3. The first hollow profile comprises a number of beads 5, which extend in the axial direction A and which are arranged so as to be spaced apart from each other in the circumferential direction U. In FIG. 1a the beads 5 extend from the end 7 of the first hollow profile 2 in the axial direction A, where in this case the axial direction A runs parallel to the longitudinal axis 6.

The first hollow profile 2 was first provided with the beads 5 in a stamping tool (not shown in greater detail) comprising a top and bottom tool. In so doing, the walls of the first hollow profile 2 were pulled inward in certain regions, in order to form the beads 1 Outside the bead regions the first hollow profile 2 was deformed only to a small degree. It can be seen in FIG. 1b that a total of four beads 5 have been produced here, so that the result is a somewhat cross-shaped cross section for the first hollow profile 2 in the profile section that is located in the overlapping region 4. In this procedure with a tool comprising a top and bottom tool it is advantageous if a cross section, which is symmetrical relative to the horizontal plane H, is produced with an even number of beads, thus, four or six or eight heads, etc.

Thereafter the hollow profiles 2, 3 were arranged one inside the other, with the two hollow profiles 2, 3 being dimensioned in such a way that a press fit is formed. The outer surface 9 of the first hollow profile 2 comes into contact with the inner surface 8 of the second hollow profile 3 in certain regions, with the inner first hollow profile 2 being supported on the outer second hollow profile 3. The result of the deformation, caused by the heads 5, in the material and the press tit is the presence of radially outwards acting restoring forces in the material, which has the effect that the inner first hollow profile 2 is pressed against the outer second hollow profile 3. The result of this arrangement is that the press fit connection is reinforced even more.

The strength of the restoring forces also depends on the depth of the beads 5 and, in general, on the degree of deformation during the production of the heads 5. The magnitude of the restoring forces generated is in direct correlation with the function that the press fit between the hollow profiles 2, 3 is supposed to assume. If the press fit alone is to ensure the connection between the two hollow profiles 2, 3, then the active forces must be higher than if only the relative position of the two hollow profiles 2, 3 is to he maintained relative to each other. In the latter case the connection is usually achieved by material bonding. The press fit makes it possible for the hollow profiles 2, 3 to be held in a fixed position relative to each other until, for example, an adhesive has cured or until the heat input during a welding operation has been prevented from causing the parts to distort.

It is very clear from the cross sectional view in FIG. 1b that a cavity between the first hollow profile 2 and the second hollow profile 3 is formed by the heads 5. This cavity is ideally suited as a reservoir or receiving space for an adhesive or solder (not shown in greater detail). However, even in the case of a welded joint between the first hollow profile 2 and the second hollow profile 3 the beads 5 can have an additional effect, since they are used as venting lines for welding gases, so that it is possible to produce more stable welds without gas occlusions, in this respect it has been demonstrated to be particularly advantageous, if the beads 5 extend from the end 7 of the first hollow profile 2. This configuration shows very clearly once again the advantages of the invention with respect to the assembly of the support structure 1.

The hollow profiles 2, 3 are constructed according to their application. In particular, if the geometry of the profiles is adapted to the requirements, then it is possible to adjust the mechanical properties precisely. In FIG. 1a the crass section of the second hollow profile 3 varies in the axial direction A. In a first section a the second hollow profile 3 has a large cross section, respective diameter. In a second section b in the direction of the overlapping region 4 the cross section is reduced to a smaller diameter (third section c). Finally the end of the second hollow profile 3 in a fourth section d is widened once again, so that, when a compressive load is applied, the second hollow profile 3 can be supported on the first hollow profile 2 and vice versa.

This aspect is particularly advantageous, if the support structure 1 in the motor vehicle is used in crash relevant regions, because then the support structure 1 will be able to better withstand a collision-induced compressive load in the axial direction A.

The support structure 1, shown in FIGS. 2a and 2b, differs from the support structure described above primarily by the fact that both the first hollow profile 2 and the second hollow profile 3 are provided with beads 10, 11 in the overlapping region 4. During the production of the support structure 1, the two hollow profiles 2, 3 were first arranged one inside the other and then inserted into a tool, which is equipped with a top and bottom tool in a manner analogous to the preceding exemplary embodiment. Then both hollow profiles 2, 3 were deformed at the same time. In so doing, the inner first hollow profile 2 is provided with beads 11, where in this case the heads 10 of the outer second hollow profile 3 engage with the beads 11 of the first hollow profile 2. The inner surface 8 of the second hollow profile 3 and the outer surface 9 of the first hollow profile 2 rest with their entire surface against each other. In the present embodiment six beads 10, 11 were introduced symmetrically relative to the horizontal plane H. In this case the degree of deformation is also relatively high, so that the cross section of both hollow profiles 2, 3 in the region of the beads 10, 11 is configured more or less in the shape of a star (FIG. 2b). In principle, however, in this design variant the strength of the press fit can also be adjusted by means of the degree of deformation, and this press fit may be used as a useful assembly tool for the subsequent gluing or welding processes.

The result of this embodiment of the invention is that, besides a possible press fit and a material bonded joint, a positive connection is also produced in the overlapping region 4, so that when a compressive load or a tensile load in applied in the axial direction, a secure and undetachable joint is present.

The inventive support structures 1 for a motor vehicle may be used preferably as an instrument panel support structure. FIG. 3 shows in schematic form such an embodiment of the invention. The support structure 1 comprises a first hollow profile 2 and a second hollow profile 3, with both hollow profiles being arranged one inside the other in an overlapping region 4. The ends of the support structure 1 have coupling sections 12, 13, where the support structure 1 is attached by means of the coupling elements 14, 15 to the A-pillar of the motor vehicle. These coupling elements may be flanges, recesses, threaded holes and the like.

The second hollow profile 3 is provided with holding devices 16, 17, on which the instruments and the steering are mounted in the region of the driver's seat. Since higher loads are usually applied to the support structure 1 in the region of the driver's seat, the second hollow profile 3 has a large cross section there.

The first hollow profile 2 has a bead 20 that is spaced apart from the overlapping region 4. In this case it involves an attachment point for a holding device 19.

The connection between the first hollow profile 2 and the second hollow profile 3 is designed as shown in FIG. 2. Only the beads 10 of the second hollow profile 3 are marked in FIG. 3. However, these heads are used not only fix their main purpose, i.e. to produce a secure and stable connection, but they are also used at the same time as an attachment point for a holding device 18.

In this embodiment the second hollow profile 3 is a profile constructed by roll forming or UO forming, since this production process fulfills the objective of making the necessary variation in the cross section in the axial direction A easy and uncomplicated. The steel material that is used is provided as a sheet or coil and is trimmed according to the predetermined configuration of the cross section. After the steel sheet has been formed into the hollow profile 3, the edges, which are standing one on top of the other, are welded at least in certain regions. Thereafter, the recesses, heads, grooves and the like are produced as coupling elements 14 or attachment points.

The first hollow profile 2 is made of a lightweight metal, such as, for example, aluminum or magnesium, and is produced in an extrusion or pultrusion process. Here, too, the production step is followed by mechanically processing with trimming and the introduction of beads, grooves or recesses.

The two hollow profiles 2, 3 are arranged one inside the other and are placed into a tool, in which the beads 10, 11 are introduced in the overlapping region 4 of both hollow profiles 2, 3. In this case the first hollow profile 2, made of a lightweight metal, is disposed internally, and the second hollow profile 3, made of steel, is disposed externally. As a result, the material properties of the components are utilized. Both profiles are deformed to a similar degree of deformation. As a result, the radially inward acting deforming forces are counteracted by the radially outward acting restoring forces that are higher in a lightweight metal, such as, for example, aluminum or magnesium, than in steel materials. Thus, the first hollow profile 2 pushes radially outwards in the overlapping region 4. This feature is not so accentuated in the case of the second hollow profile 3, so that this hollow profile represents an abutment for the radially outward acting threes, which has the effect that a stronger, more stable press fit is produced.

### LIST OF REFERENCE NUMERALS AND CHARACTERS

1—support structure

2—first hollow profile

3—second hollow profile

4—overlapping region

5—bead of 2

6—longitudinal axis

7—end of 2

8—inner surface of 3

9—outer surface of 2

10—bead of 3

11—bead of 2

12—coupling section

13—coupling section

14—coupling element

15—coupling element

16—holding device

17—holding device

18—holding device

19—holding device

20—bead

A—axial direction

H—horizontal plane

U—circumferential direction

a—first section

h—second section

c—third section

d—fourth section

1. Support structure (1) for a motor vehicle, said support structure comprising at least one first and one second hollow profile (2, 3), with both hollow profiles being arranged one inside the other in an overlapping region (4) and with both hollow profiles being arranged in the overlapping region (4) in such a way that they about each other at least in certain regions, characterized in that the inner first hollow profile (2) has a plurality of beads (5, 11), which extend in the axial direction A and are arranged in the circumferential direction U, at least in the overlapping region (4).

2. Support structure, as claimed in claim 1, characterized in that the beads (5, 11) of the first hollow profile (2) extend from its end, which is disposed in the second hollow profile (3), in the axial direction A.

3. Support structure, as claimed in claim 1, characterized in that the outer second hollow profile (3) also has heads (10) that engage at least partially with the beads (5, 11) of the inner first hollow profile (2).

4. Support structure, as claimed in claim 1, characterized in that the beads (5, 10, 11) extend beyond the overlapping region (4).

5. Support structure, as claimed in claim 1, characterized in that at least one of the hollow profiles (2, 3) has a cross section that varies in the axial direction A.

6. Support structure, as claimed in claim 5, characterized in that at least one of the two hollow profiles (2, 3) has a cross section that tapers towards the overlapping region (4).

7. Support structure, as claimed in claim 5 or 6, characterized in that in at least one of the two hollow profiles (2, 3) the end, located on or in the overlapping region (4), is widened.

8. Support structure, as claimed in claim 1, characterized in that at least one of the hollow profiles (2, 3) has locally varying wall thicknesses.

9. Support structure, as claimed in claim 1, characterized in that one hollow profile (2, 3) is made of a light metal material; and one hollow profile (2, 3) is made of a steel material.

10. Support structure as claimed in claim 1, characterized in that one of the hollow profiles (2, 3) has a coating, made of a metallic material, on at least its surface regions that come into contact with another hollow profile (2, 3).

11. Support structure, as claimed in claim 1, characterized in that the two hollow profiles (2, 3) are connected to each other by material bonding at least in certain regions.

12. Support structure, as claimed in claim 11, characterized in that the beads (5, 11) of the first hollow profile (2) are filled with adhesive or soldering material in the overlapping region (4).

13. Support structure, as claimed in claim 1, characterized in that the support structure (1) is an instrument panel support structure.

14. Method for producing a support structure (1) for a motor vehicle, said method comprising the following steps:
providing at least one first and one second hollow profile (2, 3)
deforming at least the first hollow profile (2) in such a way that the walls of the first hollow profile (2) are pulled inward in certain regions in an overlapping region (4) of the two hollow profiles (2, 3), so that beads (5, 11), which extend in the axial direction A and are arranged so as to be spaced apart in the circumferential direction U, are formed
arranging the first and second hollow profile (2, 3) one inside the other in such a way that before or after deforming the first hollow profile (2), the outer surface of the inner first hollow profile (2) comes into contact with the inner surface of the outer second hollow profile (3) at least in certain regions in an overlapping region (4).

15. Method, as claimed in claim 14, characterized in that a layer of adhesive or a welded joint or a soldered joint for forming a material bonded Mint between the two hollow Profiles (2, 3) is arranged at least in certain regions between the first and the second hollow profile (2, 3).

16. Method, as claimed in claim 14, characterized in that the first hollow profile (2) is deformed before arranging the hollow profiles (2, 3) one inside the other.

17. Method, as claimed in claim 16, characterized in that in another process step the beads (5, 11) of the inner first hollow profile (2) are filled with an adhesive, before arranging the hollow profiles (2, 3) one inside the other.

18. Method, as claimed in claim 14, characterized in that the inner first hollow profile (2) and the outer second hollow profile (3) are deformed after arranging one inside the other.

19. Method, as claimed in claim 18, characterized in that the first and the second hollow profiles (2, 3) are deformed in such a way that in the overlapping region (4) the walls of the hollow profiles (2, 3) are pulled inwards, so that beads (10, 11) are formed, wherein the beads (10) of the outer second hollow profile (3) engage with the beads (11) of the inner first, hollow profile (2).

20. Method, as claimed in claim 14, characterized in that outward projecting attachment elements are formed in at least one of the two hollow profiles (2, 3).

21. Method, as claimed in claim 14, characterized in that at least one of the two hollow profiles (2, 3) is produced by means of a UO forming process.

22. Method, as claimed in claim 14, characterized in that at least one of the two hollow profiles (2, 3) is produced by means of an extrusion or pultrusion process.
